(19) United States
(12) Patent Application Publication
(10) Pub. No.: US 2008/0244535 A1
(43) Pub. Date: Oct. 2, 2008

(54) Logging and Replaying Input/Output Events for a Virtual Machine

(75) Inventors: Michael Nelson, Alamo, CA (US); Ganesh Venkitachalam, Mountain View, CA (US)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/058,465

(22) Filed: Mar. 28, 2008

Related U.S. Application Data
(60) Provisional application No. 60/920,651, filed on Mar. 28, 2007.

(51) Int. Cl. G06F 9/44

(52) U.S. Cl. 717/129

(57) ABSTRACT

Methods for logging and replaying input/output (I/O) events for a virtual machine (VM). The I/O events may be asynchronous or synchronous. In particular, one embodiment is a computer-implemented method for logging input/output (I/O) events for a virtual machine, the method including: executing the virtual machine from a checkpoint; and logging external events, including I/O events; wherein logging an I/O event comprises logging the event, and then, logging I/O data relating to the I/O event.

This application claims the benefit of U.S. Provisional Application No. 60/920,651, filed Mar. 28, 2007, which provisional application is incorporated herein by reference in its entirety.

### FIELD OF THE INVENTION

One or more embodiments of the present invention relate to logging and replaying events for a virtual machine. In particular, one or more embodiments of the present invention relate to logging and replaying input/output (I/O) events for a virtual machine.

### BACKGROUND

Advantages of virtual machine technology or virtualization have become widely recognized. Among these advantages is an ability to run multiple virtual machines on a single host platform. This makes better use of hardware capacity while offering users features of a “complete” computer. Depending on how it is implemented, virtual machine technology can provide greater security, since it can isolate potentially unstable or unsafe software so that it cannot adversely affect a hardware state or system files required for running the physical (as opposed to virtual) hardware. As is well known in the field of computer science, a virtual machine (VM) is an abstraction—a “virtualization”—of an actual physical computer system.

Replay of VM instruction execution is useful for debugging, fault tolerance, and other uses. To ensure correct replay, the replay of each input/output (I/O) event for the virtual machine needs to occur at the same point at which it occurred in the original VM instruction execution sequence.

### SUMMARY

One or more embodiments of the present invention are methods for logging and replaying input/output (I/O) events for a virtual machine (VM). The I/O events may be asynchronous—Direct Memory Access (DMA) is an example of an asynchronous I/O event—, or the I/O events may be synchronous—Programmed Input/Output (PIO) is an example of a synchronous I/O event.

In particular, one embodiment of the present invention is a computer-implemented method for logging input/output (I/O) events for a virtual machine, the method comprising: executing the virtual machine from a checkpoint; and logging external events, including I/O events; wherein logging an I/O event comprises logging the event, and then, logging I/O data relating to the I/O event.

### BRIEF DESCRIPTION OF THE DRAWINGS

FIG. 1 illustrates a virtualized computer system that is fabricated in accordance with an embodiment of the present invention.

FIG. 2 depicts a flow chart showing an exemplary logging mode in accordance with one embodiment of the present invention.

### DETAILED DESCRIPTION

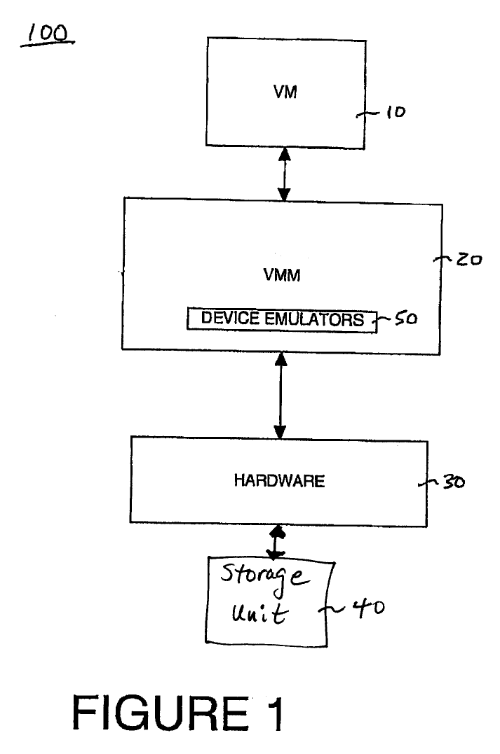

FIG. 1 shows virtualized computer system 100 that is fabricated in accordance with one or more embodiments of the present invention. As shown in FIG. 1, virtualized computer system 100 includes virtual machine (VM) 10, hardware 30, and virtual machine monitor (VMM) 20 which includes device emulators 50. Hardware 30 includes at least one processor, and as indicated in FIG. 1, storage unit 40 is part of, or accessible to, hardware 30.

Virtual machine replay is based on the notion that if one starts a virtual machine in a given state, and then provides it with the same set of inputs, at the same points in an instruction execution stream, the replay will produce the same set of outputs each time it is run. In a virtual machine replay system, a checkpoint of a virtual machine state is taken, and all external events are logged as the virtual machine executes a stream of instructions. During replay, a virtual machine (for example, one that is resumed) is replayed from the checkpoint, and it is given the external events from the log, at the same points in the replay instruction execution sequence that they occurred in the original instruction execution sequence.

In a system with replay, there may be two modes: a logging mode or a replaying mode. In the logging mode, when a VM is executing from a checkpoint, the VMM logs all external events, including interrupts and I/O operations. However, in the replaying mode, when a VM is replaying from the checkpoint, the VMM reads the external events from the log, and applies them to the replaying VM (for example, a resumed VM).

In operation, a VM issues an I/O request to a device, and then continues execution. At some point in the future, the I/O request completes, an interrupt is raised, and the VM processes the I/O completion. An I/O completion is generally indicated by changing a state in an entry in some I/O queue. For example, for networking, a VM normally fills a queue with buffers to receive data, and marks each buffer as empty. When a packet is received, the buffer is marked as full. A similar methodology is used for SCSI devices and others. Asynchronous I/O is normally done via direct memory access (DMA). When an I/O request is issued to a DMA device, it is given a physical address defining where to read or write the result. In this case of a result being written to physical memory, the write occurs at some point after the I/O request issued, and before the I/O completion is posted. Thus, during the time between issuing the I/O request and posting its completion, the data can be in flux, and should not be used.

Each time a VM issues an I/O request, when the I/O operation completes in the future, a device emulator will have an opportunity to post the I/O completion to the VM. Note that the device emulator may be running concurrently with virtual CPU(s) (VCPU(s)) of the VM. Likewise, any DMA operation that completes can complete while the VCPU(s) of the VM are running. As such, there is a need to ensure that during replay a VM sees all I/O completions and DMA results at the same point in the replay instruction execution sequence that they occurred during the original instruction execution sequence.

In accordance with one or more embodiments of the present invention, when capturing an I/O event, the event is logged first, and then all I/O data relating to that I/O event is logged. Then, in replay, when an event is obtained from the log, the I/O data is read straight out of the log and into a final location in guest memory of the VM.

In accordance with one or more embodiments of the present invention, a device emulator uses events to deliver I/O completions and their associated data to a VM. In particular, each device emulator (for example, for different devices) allocates a unique event identifier (id) E and associates an event handler with the event id. Then, when an I/O completion needs to be delivered to the VM, during logging, an event-request is posted with event id E for the virtual machine monitor (for example, VMM 20). In accordance with one or more such embodiments, this may be implemented as a MonitorAction that the VMM will process the next time it runs. Then, when the VMM processes the event-request, it stops the VM, synchronizes the guest VCPU state, and then calls the associated event handler. The event handler typically logs an event so the event can be replayed, and then logs any data associated with the event. Later, when the event is encountered in the log during replay, the event handler will be called, and it will then read any event data from the log.

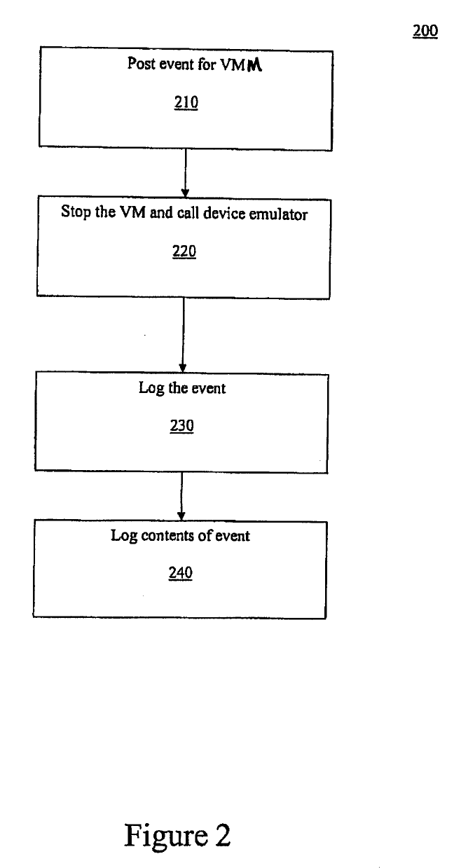

Networking will be used as an example to explain how a logging mode works in accordance with a first embodiment of the present invention. Reference is made to FIG. 2, which depicts flow chart 200 showing the logging mode of the first embodiment of the present invention. Other devices, such as SCSI devices work in a similar manner.

For incoming network packets, the following is done during the logging mode. When a packet is received, an event-request is posted for the VMM, at Block 210. When the VMM processes the event, it stops the VM, synchronizes the guest VCPU state, and then calls into the device emulator (i.e., device emulation software event handler), at Block 220. The device emulator logs an event at Block 230. Then, the device emulator receives the packets, and logs their contents, at Block 240. The last packet logged is marked so that during replay the device emulator can know when the last packet for this event occurs in the log.

During replay the following occurs: When an I/O event is encountered in the log, the device emulator (i.e., device emulation software event handler) is called by the VMM. The device emulator reads all packets that were logged, and copies them into the memory of the VM. In this way, the receive queue of packets is updated at the exact same point in the instruction execution sequence during logging and replay.

Packet transmits can be synchronous or asynchronous. Synchronous transmits occur when a VM writes a command to a virtual device to transmit a packet. This can be handled through the above-described methods. However, asynchronous transmits occur when a routine periodically scans a transmit queue for pending packets. During a logging mode, if the routine sees pending packets, it posts an event-request for the VMM, as described above. When the I/O event is eventually processed by the device emulator, an I/O event is logged, all packets are transmitted, the transmit queue is updated, and an entry is logged with a count of transmitted packets.

During replay the following occurs. Any periodic transmit routines are disabled—transmits may occur either from synchronous VM calls or via logged I/O events. When a transmit I/O event is encountered, all pending transmit packets are sent, and the transmit queue is updated. As a follow-on check, the transmit count that was logged with the event is verified to make sure that the same number of packets is transmitted.

A potential issue with DMA writes is that the original VM will see different data in a DMA page than the replayed VM will see. This potential issue is prevented in the following manner. During logging and replay, before an I/O request is posted to physical hardware, the DMA buffers are unmapped from the VM physical address space until the I/O completion is posted to the VM. If the VM tries to access a buffer before the I/O completes, the VM is blocked until the I/O completion is posted to the VM. In this way, a logging VM behaves analogously to a replay VM for asynchronous I/O.

Synchronous IO usually occurs with PIO. The x86 architecture, for example, has PIO instructions such as IN/INS/OUT/OUTS that read/write bytes from/to a specified port. Ports are “backed” by a physical device. The device supplies values read, and is responsible for dealing with values written. In a virtual machine, a virtual machine monitor traps accesses to these ports, and dispatches the traps to whichever physical device owns the port. The device emulator computes the necessary value to give back to the VM on a read, and updates a device emulation state on a write.

In a logging mode in accordance with a second embodiment of the present invention, the virtual machine layer can carry out the required operations in a manner analogous to that carried out for PIO ports (which PIO ports can be identified at virtual machine PowerOn), except for a noted difference. That is, for all values supplied back to the VM by the device emulator, the virtual machine monitor can log the actual value to the log file as well.

Then, in a replay mode in accordance with the second embodiment of the present invention, when the VM writes to any such port, the value written can be simply ignored. When the VM reads from such a port, the value can be supplied from the log file to the VM. Because execution is deterministic, all port accesses will occur at the same execution points at replay time and at logging time, and thus have a recorded value in the log to give back to the VM at replay time.

Note that if such embodiments are used, there is no way to continue VM execution past the end of the log, because device state is not being updated at all during replay. Therefore the device emulator will have no way to continue execution. A potential solution to this issue is as follows: when logging, along with values read by the VM, the VMM (or the device emulator) can checkpoint its internal state, and write it to the log file. Then, on replay, when the end of the log file is reached, the respective device state can simply be restored from the checkpointed state and continued.

In accordance with one or more third embodiments of the present invention, replay of synchronous I/O that provides an ability to continue past the end of the recorded log file occurs as follows: while logging, the virtual machine layer can carry out the required operations in a manner analogous to that carried out for PIO ports. While replaying, trap the special PIO instructions, and route these accesses to a device emulator in a manner similar to logging. The respective devices are then responsible to make sure that the value they supply back to the VM on a read access is the same as the value supplied at logging time at the same execution point. For some devices, this is a straightforward issue, e.g. a keyboard controller emulator can log keystrokes at logging time, and replay them at replay time, and keep the emulation state up-to-date. However, for other devices where the emulation state can be changed in non-deterministic ways, this may be more difficult, e.g., a timer device might depend on time elapsed on a host platform to deliver a particular value to the VM on a read access. In such cases, the device emulator may need to log all such values to the log file at logging time, or rely on a mixture of the two techniques.

Embodiments as described above may be implemented as computer-executable instructions stored in a computer-readable medium, such as a magnetic disk, CD-ROM, an optical medium, a floppy disk, a flexible disk, a hard disk, a magnetic tape, a RAM, a ROM, a PROM, an EPROM, a flash-EPROM, or any other medium from which a computer can read. The instructions are executed by processors to implement the described methods and/or processes.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A computer-implemented method for logging input/output (I/O) events for a virtual machine, the method comprising:
executing the virtual machine from a checkpoint; and
logging external events, including I/O events;
wherein logging an I/O event comprises logging the event, and then, logging I/O data relating to the I/O event.

2. The computer-implemented method of claim 1 wherein logging further comprises:
a device emulator allocating an event identifier to an I/O event request from the virtual machine, and associating an event handler with the event identifier;
when an I/O event completion needs to be delivered to the virtual machine, posting an event-request with the event identifier for a virtual machine monitor; and
when the virtual machine monitor processes the event-request, the virtual machine monitor acting by: stopping the virtual machine, synchronizing a guest virtual CPU state, and then, calling the associated event handler function.

3. The method of claim 2 wherein the event handler logs the event, and then, logs any data associated with the event.

4. The method of claim 2 wherein the I/O event relates to incoming network packets:
when a packet is received, posting the event-request for the virtual machine monitor;
when the virtual machine monitor processes the event-request, the virtual machine monitor acting by: stopping the virtual machine, synchronizing a guest virtual CPU state, and then, calling the associated event handler function; and
the event handler function acting by: logging the event, receiving the packets, logging their contents, and marking the last packet in the log.

5. The method of claim 1 wherein an I/O event is a DMA event, further comprises:
unmapping DMA buffers from virtual machine physical address space before an I/O request is posted to physical hardware on which the virtual machine runs; and
remapping the DMA buffers before an I/O completion is posted to the virtual machine.

6. A computer-implemented method for replaying a virtual machine which comprises:
executing the virtual machine from a checkpoint; and
reading external events, including I/O events, from a log;
when an I/O event is encountered in the log, calling a device emulator; and
the device emulator reading all packets in the log, and copying them into memory of the virtual machine.

7. A computer-implemented method of replaying I/O events for a virtual machine, the method comprising:
when the virtual machine issues an I/O request:
logging the I/O request, including an associated identifier;
placing a request descriptor into a request queue; and
issuing the I/O request to an underlying platform;
when the I/O request completes:
deferring I/O completion until a subsequent interrupt; and
when the subsequent interrupt is raised:
stopping the virtual machine;
processing all completions;
finding a corresponding I/O request in the request queue, and
posting the completion to the virtual machine

8. A computer-implemented method for logging input/output (I/O) events for a virtual machine, the method comprising:
during logging, using a virtual machine monitor and a device emulator so that the virtual machine monitor stops the virtual machine, and the device emulator logs an I/O event; and
during replay, stopping the virtual machine when an I/O event is encountered in a log.

9. The method of claim 8 wherein using further comprises posting the I/O event to the virtual machine.

10. The method of claim 9 wherein using further comprises the device emulator logging contents of the I/O event.

11. The method of claim 8 wherein stopping further comprises:
before stopping the virtual machine when an I/O event is encountered in a log, placing contents of the I/O event where it cannot be seen by the virtual machine.

12. The method of claim 11 wherein stopping further comprises, after stopping the virtual machine, making visible the contents of the I/O event to the virtual machine.

13. A computer-implemented method of replaying input/output (I/O) events for a virtual machine, the method comprising:
when the virtual machine issues an I/O request: logging the I/O request including an associated identifier, placing a request descriptor into a request queue, and issuing the I/O request to an underlying platform;
when the I/O request completes, deferring I/O completion until a subsequent interrupt;
when the subsequent interrupt is raised, stopping the virtual machine;
processing all I/O completions, finding a corresponding I/O request in the request queue, and posting the completion to the virtual machine; and
during the replaying, avoiding issuing an I/O request from the virtual machine since a corresponding result has already been logged.

14. The method of claim 13 further comprising:
when a logged I/O completion entry is encountered, placing it onto a first queue for future use wherein the I/O completion entry comprises a unique identification.

15. The method of claim 14 further comprising:
when any physical I/O completes, notifying an emulator and placing information about the I/O completion into a second queue wherein a unique ID for the I/O request is contained in the queue entry.

16. The method of claim 15 wherein all entries in the first queue are processed upon the stopping the virtual machine.

17. The method of claim 16 wherein the virtual machine blocks until the I/O completes provided there is no corresponding completion in the first queue with a same unique identification as corresponding to the second queue.

18. A computer readable medium comprising instructions that when executed by a processor implement a method of logging input/output (I/O) events for a virtual machine, the method comprising:
executing the virtual machine from a checkpoint; and
logging external events, including I/O events;
wherein logging an I/O event comprises logging the event, and then, logging I/O data relating to the I/O event.

19. The computer readable medium of claim 18 wherein the method further comprises:
a device emulator allocating an event identifier to an I/O event request from the virtual machine, and associating an event handler with the event identifier;
when an I/O event completion needs to be delivered to the virtual machine, posting an event-request with the event identifier for a virtual machine monitor; and
when the virtual machine monitor processes the event-request, the virtual machine monitor acting by: stopping the virtual machine, synchronizing a guest virtual CPU state, and then, calling the associated event handler function.
